(19) United States
(12) Patent Application Publication
(10) Pub. No.: US 2005/0144480 A1
(43) Pub. Date: Jun. 30, 2005

(54) Method of risk analysis in an automatic intrusion response system

(76) Inventors: Young Tae Kim, Seoul (KR); Ho Jae Lee, Gyeonggi-Do (KR); Chung Sup Choi, Seoul (KR); Kang Shin Lee, Gyeonggi-Do (KR); Hong Sub Lee, Seoul (KR)

Correspondence Address: SCHWEITZER CORNMAN GROSS & BONDELL LLP, 292 MADISON AVENUE - 19th FLOOR, NEW YORK, NY, 10017, US

(21) Appl. No.: 11/009,207

(22) Filed: Dec. 10, 2004

(30) Foreign Application Priority Data
Dec. 29, 2003 (KR) 10-2003-0099103

(51) Int. Cl. H04L 9/32

(52) U.S. Cl. 713/201

(57) ABSTRACT

The present invention relates to a method of risk analysis in an automatic intrusion response system that provides computer-related security in a large scale dynamic network environment, comprising: (a) classifying intrusion detection information by using IDMEF data model; (b) establishing a risk assessment knowledge base; (c) learning rules of said knowledge base; and (d) assessing the risk level of an external attack based upon said knowledge base. Said risk level is determined by parameters such as intrusion detection information, weakness information, network bandwidth, system performance and importance, and frequency of attacks, etc.

### BACKGROUND OF THE INVENTION

1. Field of the Invention

The present invention relates to a method of risk analysis in an automatic intrusion response system that provides computer-related security in a large scale dynamic network environment, comprising: classifying intrusion detection information by using the IDMEF data model; establishing a risk assessment knowledge base; learning rules of said knowledge base; and assessing risk level of an external attack based upon said knowledge base. Said risk level is determined by parameters such as intrusion detection information, weakness information, network bandwidth, system performance and importance and frequency of attacks, etc.

2. Prior Art

In relation to the automatic intrusion response system responding to attacks on the network, there have been researches on: (i) links to security components such as firewalls, routers and intrusion prevention systems (IPS); (ii) including the simple response function in intrusion detection systems (IDS); or (iii) intrusion detection and response protocols such as the intrusion detection isolation protocol (IDIP) or the common intrusion detection framework (CIDF).

The response functions of various security components merely provide passive response in the local level through the local detection. Thus, they cannot provide efficient and flexible response mechanism in a large scale distributed network environment.

For example, first, the current intrusion detection system generates a great amount of false alarms. As lots of such false alarms will consume a great amount of time at the processing stage of almost all analysis systems, quick response will be difficult. Thus, it is necessary for an automatic intrusion response system to distinguish serious attacks and dangerous attackers among various alarms.

Second, efficient management of the current intrusion detection system requires special efforts. Particularly, every time when a new attack is discovered, an intrusion detection pattern must be prepared or renewed and it is necessary to check whether there is any threatening element by conducting periodical log analyses. Therefore, it is preferable to treat the large-scale network area as the response area and set the appropriate security and response policy, thus reducing the management responsibility of the security manager.

Third, as attacks are delivered in diverse and intelligent manners, transformed attacks and new attacks are continuously discovered. However, diverse and efficient mechanisms that may support flexible responses to such new intrusion detection information are not yet available.

Fourth, most of the security systems support only a local security and response policy. Thus, at the present time when the network usage is expanded as the Internet is actively utilized, it is necessary to adopt an appropriate response policy in the large-scale network. In other words, rather than a uniform and simple response method, it is preferable to support response policies flexibly according to relevant security requirement level and risk level.

### SUMMARY OF THE INVENTION

The present invention has been proposed to resolve the above-described problems. If the analysis method according to the present invention is used, the risk level of an information system against cyber attacks may be automatically assessed and thus it is possible to appropriately respond to the relevant attacks.

Accordingly, the object of the present invention is to provide a method of risk analysis in an automatic intrusion response system.

In order to achieve the above objects, the present invention provides a method of risk analysis in an automatic intrusion response system that provides computer-related security in a large-scale dynamic network environment, comprising: (a) classifying intrusion detection information by using the IDMEF data model; (b) establishing a risk assessment knowledge base; (c) learning rules of said knowledge base; and (d) assessing risk level of an external attack based upon said knowledge base.

In order to ensure efficiency and accuracy of the risk analysis mechanism, the present invention comprises: utilizing the IDMEF data model that supports compatibility and expandability of various and heterogeneous intrusion detection information; establishing a high-level risk assessment knowledge base for efficiently learning and classifying intrusion detection information and system weakness according to relevant risk levels; utilizing C4.5 machine learning technique for learning rules stored in said knowledge base; and utilizing Adaboosting meta learning technique for classifying said rules.

### BRIEF DESCRIPTION OF THE DRAWINGS

FIG. 1 illustrates an automatic intrusion response system adopting the analysis method according to the present invention.

FIG. 2 illustrates interactions of the components for establishing effective security and response policy of an automatic intrusion response system.

FIG. 3 illustrates a basic model of the dynamic response of an automatic intrusion response system.

FIG. 4 illustrates the procedures of a risk analysis mechanism.

FIG. 5 illustrates actions taken for assessing risk level of an information system.

FIG. 6 and FIG. 7 illustrate the highest class and specified classes of the IDMEF class obtained by parsing the intrusion detection information generated by an intrusion detection system when an mstream DDos attack occurs.

FIG. 8 illustrates detection information generated variously according to the relevant intrusion detection environment and technology.

FIG. 9 illustrates the basic structure of the IDMEF data model.

FIG. 10 illustrates specified structure of the IDMEF data model.

FIG. 11 illustrates examples of rules of a risk assessment knowledge base representing intrusion detection information and weakness information.

FIG. 12 illustrates the AdaBoost algorithm.

FIG. 13 to FIG. 16 illustrate error rate, training speed, recall and precision when C.4.5, Decision Stump, IB1, PART, and Naïve Bayes are used as tools for learning rules of the knowledge base in a risk analysis method according to the present invention.

### DETAILED DESCRIPTION OF THE PREFERRED IMPLEMENTATION

Reference will now be made in detail to the risk analysis method according to preferred embodiments of the present invention as illustrated in the accompanying drawings.

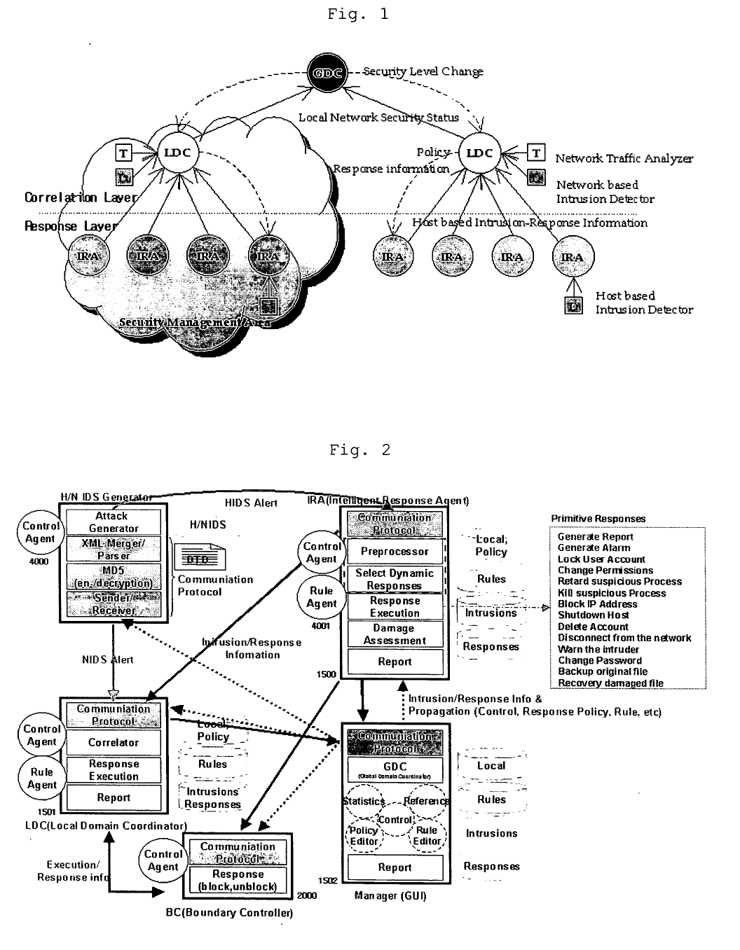

An automatic intrusion response system adopting the risk analysis method according to the present invention comprises two layers: a response layer and a correlation layer. FIG. 1 illustrates an automatic intrusion response system. Said response layer comprises an intrusion detection information generating portion (D) such as an intrusion detection system, response method deciding portions (intelligent response agents; IRAs) and a response execution portion (not shown in the drawing). The response layer executes the preliminary response to an attack or the optimum response searched in the correlation layer if an intrusion detection information arises upon an attack.

The IRA decides how to respond to an attack from the outside, which is detected in the intrusion detection system. This decision is made according to the learned previous intrusion detection and response information, risk level of the intrusion detection information (severity and intent of the attack), risk level of the information system and the current system protection level, etc. A decided response is recorded as meta information about which type of response will be made against which object.

The correlation layer comprises local domain coordinators (LDCs) and a global domain coordinator (GDC). The LDC optimizes a response by canceling or strengthening the response that has already been made upon considering the response layer's intrusion detection information, response information and other circumstantial information. The area managed by the LDC is limited to the management area (generally, it is a physical network segment representing a local security domain) specified in the LDC. Further, information related to the response made by the LDC is transmitted to the GDC. The GDC and the LDCs analyze and optimize overall circumstances in a large-scale distributed network environment.

The automatic intrusion response system comprising the response layer and the correlation layer may establish efficient security and response policy against cyber attacks. The IRA responds expeditiously to attacks on the local security domain and itself. The determination on whether the response is appropriate or not is made through the LDC and the GDC. Further, if a new information system or another network is included in the network, the structural information is registered with the relevant LDC and the GDC for efficient management of the global security domain. In other words, the IRAs, the LDCs and the GDC separately manage information systems, local security domains and the global security domain respectively. Thus, even if a new information system or another network is added, such addition does not cause any significant effect on the entire security network.

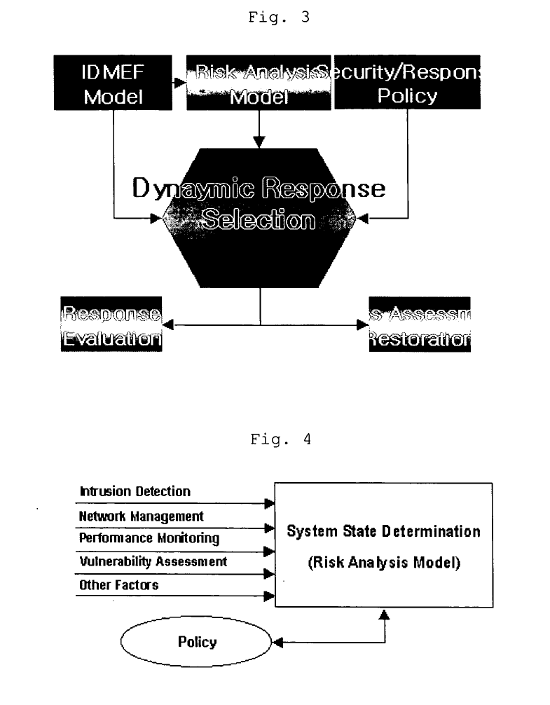

The automatic intrusion detection system further comprises an intrusion detection system (Host/Network IDS Generator), firewall (BC, Boundary Controller) and a managing tool (Manager) as components. FIG. 2 illustrates inter-operation of the components for the automatic intrusion response system's establishing the effective security and response policy.

The dynamic response procedures of said automatic intrusion detection system will now be explained in the following.

As illustrated in FIG. 2, the knowledge-based dynamic response mechanism, which is the major function of the IRA, supports the dynamic security and response policy against cyber attacks in a large-scale network environment.

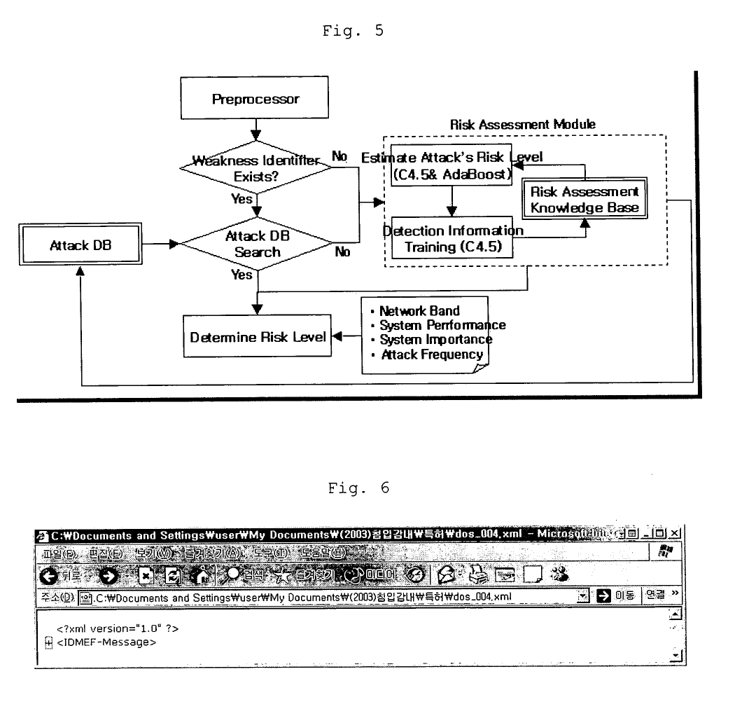

As illustrated in FIG. 3, the basic model of such dynamic response comprises procedures of classifying intrusion detection information and system weakness reported in various intrusion detection environments through the IDMEF model and the risk analysis model, determining the appropriate security and response policy, executing the local response real time and then conducting loss assessment and restoration on the damaged important data. Said dynamic response model comprises the IDMEF data model, risk analysis model, security and response policy, dynamic response selection part, response and evaluation part, and loss assessment and restoration part.

Said IDMEF data model defines data types and exchange procedures for information sharing among the intrusion detection system, the response system and the management system. The IDMEF model is designed to provide standardized representations of all detection information and to represent simple and complex intrusion detection information together according to the intrusion detection system's detection environment and capability.

The risk analysis model classifies intrusion detection information into IDMEF classes and thereafter assesses the attack's risk level (severity and intent of the attack) according to the risk assessment knowledge base established based upon said IDMEF classes. Then, based upon the risk level of the attack, the risk analysis model assesses the risk level of the information system by considering the attack frequency, system importance and other circumstantial elements, etc. This model uses C4.5machine learning technique in order to learn rules concerning intrusion information and weakness information stored in the risk assessment knowledge base and to conduct classification accordingly, and uses AdaBoost meta learning technique in order to improve the accuracy of the classification of the learned data.

Said security and response policy is managed by the security manager in order to protect the important system and network in a large-scale network environment and maybe modified automatically by the dynamic response selection mechanism.

The dynamic response selection algorithm analyzes the risk level of the information system as classified in the risk analysis model and the IDMEF classes based upon said security and response policy and accordingly selects appropriate security level and response level (response module, response method).

Said response and evaluation part is in charge of execution of the security and response policy and is used to manage and maintain the intelligent and high-performance automatic intrusion response system through evaluation of the appropriateness of the policy security level and the response level, the accuracy of the intrusion detection system, and the accuracy of the risk analysis model, etc.

If any bad file is generated or if any process' renewal or deletion occurs, said loss assessment and restoration part assesses the loss in the information system and restores damaged file or process, etc. This function assesses loss occurring in the information system independently and periodically even if there is no event from the intrusion detection system.

Now, of the dynamic response procedures of said automatic intrusion detection system, the risk analysis mechanism will be explained.

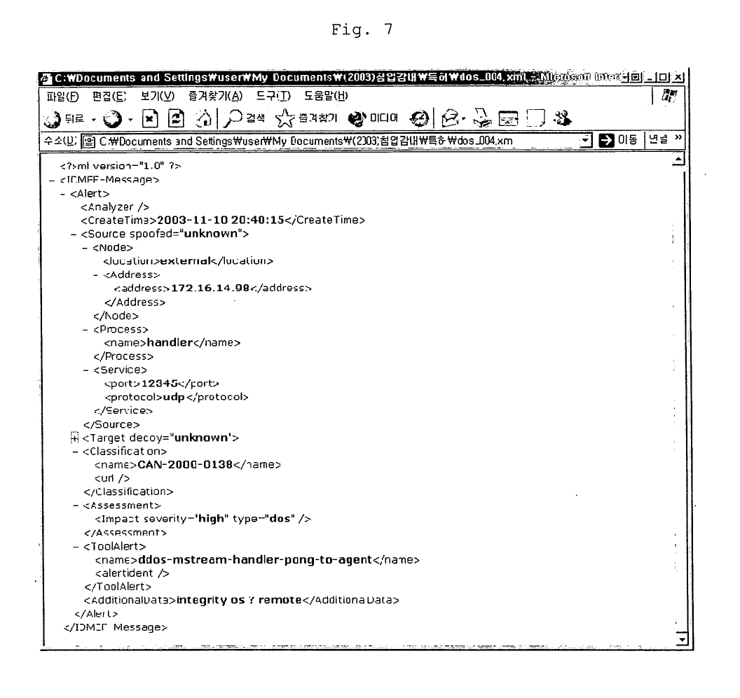

The risk analysis mechanism according to the present invention classifies risk levels of cyber attacks and assesses the risk level of the information system by using various information generated by systems such as information on intrusion detection, network management system performance and weakness assessment, etc. FIG. 4 illustrates this function.

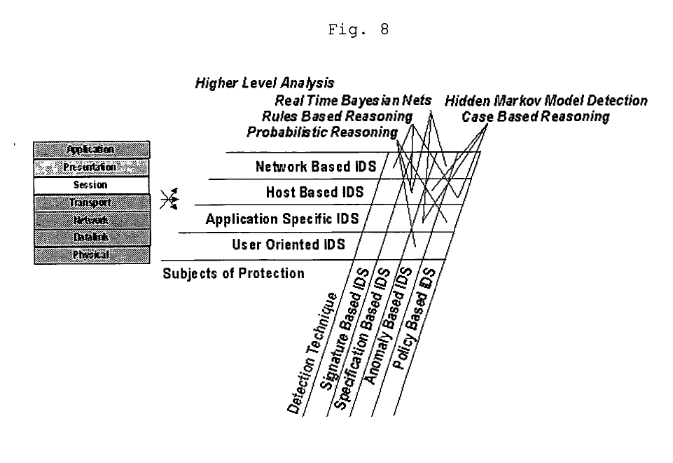

The risk analysis method according to the present invention supports a search function comprising two stages in order to accurately analyze risk levels of attacks. The operation procedures for assessment of risk level of the information system are as illustrated in FIG. 5.

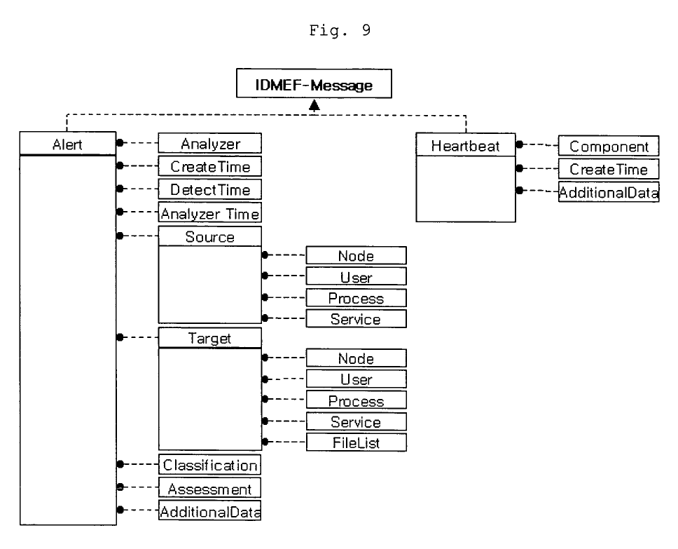

First, the pre-processor receives intrusion detection messages (IDMEF messages) generated in the XML format by various intrusion detection systems and conducts parsing according to the relevant IDMEF classes. For the parsing of the received message, “DOMParser( )” included in the XML library is used. FIG. 6 and FIG. 7 illustrate the IDMEF class obtained by parsing the intrusion detection information generated by the relevant intrusion detection system as viewed in the Internet Explorer 6.0 program.

Then, it is checked whether there exists a weakness identifier within the relevant IDMEF class. FIG. 7 illustrates the checking of whether “CAN-2000-0138” exists within the relevant class of said parsed IDMEF classes. This is the procedure to determine whether the current attack is an unknown attack. If it is an unknown attack (i.e., if there exists no relevant weakness identifier), the risk assessment module is conducted. On the other hand, if it is a known attack (i.e., if there exists the relevant weakness identifier), the attack DB search module is conducted. The risk assessment module and the attack DB search module assesses and searches, respectively, the risk level of the attack, that indicates the attack severity and intent.

The risk assessment module assesses the attack's risk level based upon the already-established risk assessment knowledge base by using the parsed IDMEF classes and the weakness database information and conducts learning by using the IDMEF classes and the attack's risk level. Further, the risk assessment module transmits the analysis result to the risk level determination module.

Preferably, said learning procedure uses C4.5 algorithm. Said classification procedure preferably uses AdaBoost algorithm that may conduct C4.5 algorithm multiple times in order to improve the accuracy.

Thereafter, the classification result concerning the unknown detection information is provided to the security manager. The security manager registers a weakness identifier with the attack database based upon the information, attack DB analysis and loss assessment result, etc., that were reported by the risk assessment module.

The attack DB search module searches the attack database by using the weakness identifier existing in the relevant IDMEF class. If the search does not locate any relevant data, the risk assessment module is conducted. If there exists a search result, the search result is transmitted to the risk level determination module.

The risk level determination module determines the risk level of the information system by using information on the risk level of the attack, network traffic amount, system performance, system importance and the frequency of the same attack, etc.

As described above, the system adopting the risk analysis mechanism according to the present invention may automatically analyze attackers' attack severity and the information system's weakness and risk level, and thus may provide support for the security and response policy based on the relevant risk level.

Now, hereinafter, the risk assessment module in charge of classifying and learning risk levels of attacks based upon intrusion detection information will be explained in detail.

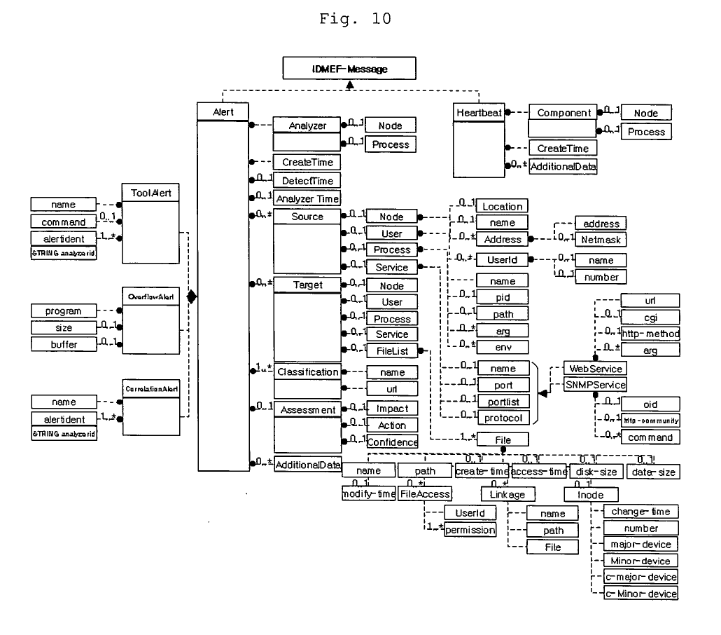

Most intrusion detection systems report heterogeneous detection information for the same attack depending on the detection circumstances and detection technology. In other words, for all attacks, known or unknown, various and heterogeneous detection information may be generated depending on the host, network or application based detection environment and the detection technology related to signatures, specification, anomalies and policy, etc. FIG. 8 illustrates the various detection information generated according to the relevant intrusion detection environment and technology.

Accordingly, in order to improve compatibility and expandability among various and heterogeneous intrusion detection systems, the present invention adopts the IDMEF (Intrusion Detection Message Exchange Format) that supports the XML format currently standardized by the IETF (Internet Engineering Task Force). The IDMEF is a standard data format used by automatic intrusion detection systems to express intrusion detection information upon occurrence of a suspicious event. The IDMEF data model is an object-oriented expression of detection information that is transmitted from the intrusion detection system to the management system.

The IDMEF data model considers the following problems that:

the detection information is inherently heterogeneous (i.e., some detection information merely includes little information such as source, destination, name and event occurrence time, etc. but some other detection information includes other information such as port or service, process and user information, etc.);

there are various different intrusion detection environments (i.e., some intrusion detection environment analyzes network traffic to detect an attack and some other detection environment uses operating system log or audit information, and accordingly detection information reported concerning the same attack in different intrusion detection environments does not always include the same information);

capabilities of intrusion detection systems are different (i.e., depending on the relevant security domain, an intrusion detection system that provides a small amount of detection information or a complicated intrusion detection system that provides a greater amount of detection information may be installed);

operating system environments are different (i.e., attacks are observed and reported differently depending on the types of the relevant networks and operating systems); and

objectives of the suppliers are different (due to various reasons, suppliers supply intrusion detection systems that provide useful and appropriate information on types of attacks according to the suppliers' classification).

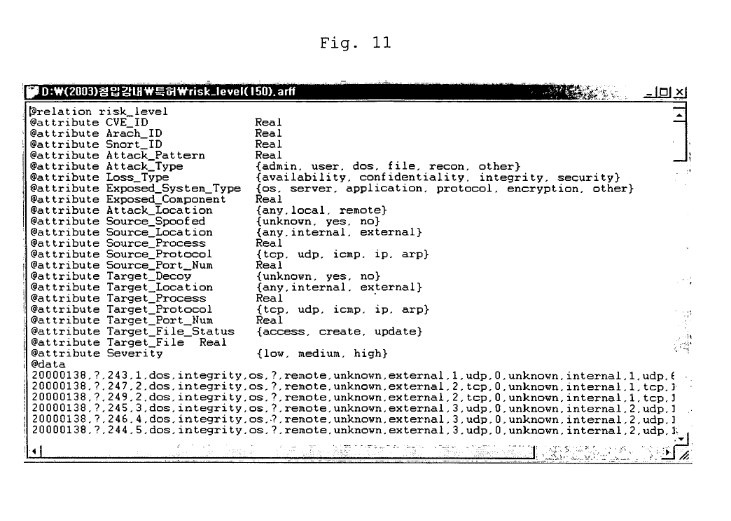

Accordingly, the IDMEF data model provides standardized expressions of all detection information and is designed to describe simple and complicated detection information together depending on the intrusion detection system's detection environment and ability. FIG. 9 illustrates the basic structure of the IDMEF data model.

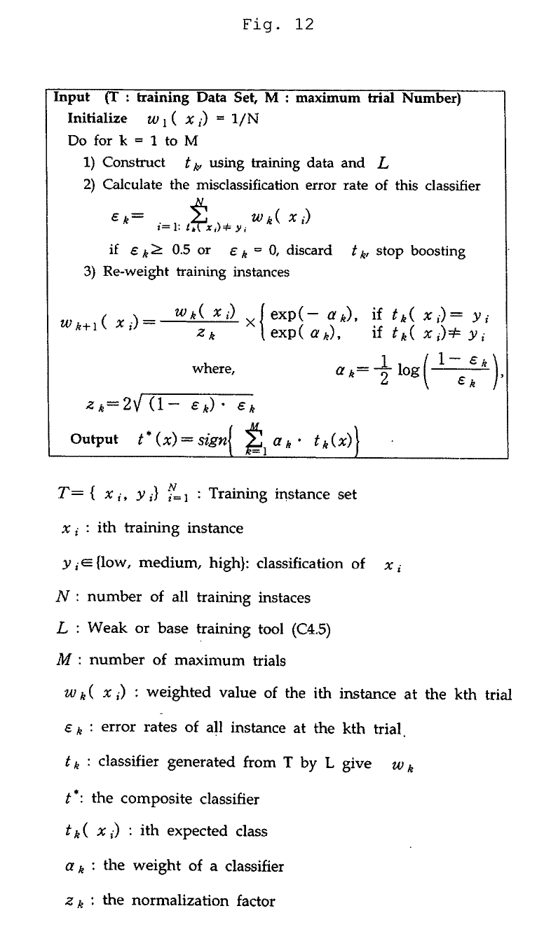

The highest class of all IDMEF messages is the IDMEF-Message class. As a class lower than said IDMEF-Message class, two types of messages (Alert and Heartbeat) exist. As illustrated in FIG. 10, in order to include detailed information within a message, the lower classes of each respective message type is used.

In order to classify attack levels including the severity and intent of cyber attacks, the present invention establishes a risk assessment knowledge base that may integrate and manage intrusion detection information and weakness information. Attributes used in said knowledge base are composed of several IDMEF classes and information in the weakness database. The IDMEF classes refer to intrusion patterns of intrusion detection systems such as Snort NIDS, Arach NIDS, etc. and the weakness information refers to the ICAT weakness database. Further, intrusion detection information, weakness information, network bandwidth, system performance and importance and attack frequency, etc. are considered.

The weakness information of an information system is determined by existence of CVE, which is the weakness identifier, within the reference field of the IDMEF. CVE exists only if the intrusion type is “admin,” “dos,” “user,” or “file.” This means that an intruder can damage the information system by using the potential weakness of the information system. On the other hand, if the intrusion type is “recon,” no CVE number is included in the reference field of the intrusion detection information. This means that an attacker attempts intrusion only for collection of various information and does not cause damage to the information system. By extracting attributes such as loss type (Loss_Type), exposed system type (Exposed_System_Type), exposed component (Exposed_Component) of the information system from the weakness database, the cause of the intrusion detection information generated by the intrusion detection system may be recognized (i.e., the intruder's intent can be known concerning which weakness of the information system has been utilized for the attack).

The following table 1 sets forth basic attributes constituting a risk assessment knowledge base including IDMEF's basic classes and attributes of the weakness database.

TABLE 1
Basic Attribute List Constituting Risk
Assessment Knowledge Base

| Attribute Name | Field | Description | Data Type |
|---|---|---|---|
| Weakness | CVE-ID | CVE, CAN number | Number |
| Identifier | | | |
| Attack Pattern | Attack_Pattern | Pattern of intrusion detection | Character |
| | | information | String |
| Attack Type | Attack_Type | Type of attack severity (admin, | Character |
| | | user, dos, file, recon, other) | String |
| Loss Type | Loss_Type | Problem with availability, | Character |
| | | confidentiality and integrity | String |
| System | Exposed_System_Type | Type of the system with weakness | Character |
| Weakness | | (os, server, application, protocol, | String |
| Type | | encryption, other) | |
| Component | Exposed_Component | System component with weakness | Character |
| Weakness | | | String |
| Type | | | |
| Attack | Attack_Location | Location where an attack started | Character |
| Location | | (local, remote) | String |
| False Source | Source_Spoofed | Whether source address has been | Character |
| Address | | falsified (unknown, yes, no) | String |
| Source | Source_Location | Location of source IP address | Character |
| Location | | (internal, external) | String |
| Source Process | Source_Process | Process that is executing in the | Character |
| | | source system | String |
| Source | Source_Protocol | Protocol used in the source system | Character |
| Protocol | | | String |
| Source Port | Source_Port_Num | Port number used in the source | Number |
| Number | | system | |
| False Target | Target_Decoy | Whether target IP address has | Character |
| | | been falsified (unknown, yes, no) | String |
| Target | Target_Location | Location of tarket IP address | Character |
| Location | | (internal, external) | String |
| Target Process | Target_Process | Process that is executing in the | Character |
| | | target system | String |
| Target Protocol | Target_Protocol | Protocol used in the target system | Character |
| | | | String |
| Target Port | Target_Port_Num | Port number used in the target | Number |
| number | | system | |
| Target File | Target_File_Status | Determine access, generation and | Character |
| Status | | renewal of non-authorized files | String |
| Target | Target-File | Damaged file in the target system | Character |
| Damaged File | | | String |
| Attack Risk | Severity | Used to quickly determine the | Character |
| level | | attack's severity and weakness | String |

The above table 1 is based upon only two types of network-based intrusion detection systems, i.e., Snort INDS and Arach NIDS. However, other network or host based intrusion detection systems may be added easily. It is possible that no content is included in the attributes such as Source_Process, Target_Process, Exposed_System _Type, Exposed_Component, and Target_File.

FIG. 11 illustrates how intrusion detection information and weakness information is expressed with rules of the risk assessment knowledge base.

As described above, the risk assessment knowledge base is established by using intrusion detection information and weakness information and said knowledge base is used to assess an attack's risk level.

Now, explanations will be provided for C4.5 machine learning technique through which attack severity may be classified and learned regarding intrusion detection information on an unknown attack and the Adaboost meta-learning technique as a boosting algorithm for raising the accuracy of the classification.

The risk assessment method according to the present invention uses J48 algorithm of WEKA library for machine learning and classification. J48 algorithm is implementation with JAVA language of C4.5 decision tree algorithm after ID3. Algorithms that may be supported in WEKA include decision tree, k-nearest neighbor, naive bayes, assocision rules, and so forth.

Said C4.5 technique performs training and classification by establishing a decision tree and thus is characterized as a decision tree algorithm. The purpose of the decision tree algorithm is to generate the optimum tree that can analyze the result. In order to generate the optimum tree, the order of selecting attributes is important. Depending on the attribute selection order, the tree's constitution degree may be different and depending on the tree's constitution degree, the tree may be complicated or simplified.

In order to determine the attribute selection order, the decision tree algorithm uses the “Information Theory,” which utilizes “Entropy” and “Information Gain.” The Entropy is the degree to which various types of classes are mixed at the current state. As there are more types of classes that are mixed, the Entropy gets higher. Further, if the numbers of data of respective types of classes are similar, the Entropy becomes even higher. Thus, if all classes are of one type, the Entropy is 0. If there are two types of classes and the numbers of data for the respective classes are the same, the Entropy is 1.

The following equation 1 sets forth an equation for measuring the Entropy.

$$Entropy ( S ) ≡ {\sum }_{i = 0}^{c} ( - {p}_{i} {log}_{2} {p}_{i} ) \qquad [ Equation 1 ]$$

where,

S is the entire data group,

c represents the class, and

Pi is probability of the ith class (c) group to the entire data group S.

The Gain is the degree to which the expected Entropy is reduced if data are classified by selecting certain attribute. That the Entropy is reduced to a high degree means that the data may be clearly classified if the relevant attribute is used. Therefore, in order to select the relevant attribute, the Gain for each attribute should be determined at the current status and then data should be separated by selecting the attribute with the highest Gain.

The following equation 2 is an equation for calculating the Gain.

$$Gain ( S , A ) ≡ Entropy ( S ) - {\sum }_{v ∈ Values ( A )}^{} \frac{\vert {S}_{v} \vert}{\vert S \vert} Entropy ( {S}_{v} ) \qquad [ Equation 2 ]$$

where,

S is the entire data group,

A is the name of one attribute,

Gain(S,A) is the degree to which the Entropy is decreased when classification is conducted in the entire data group S by selecting the attribute A,

v is the relevant attribute value of the attribute A,

Sv is the group of data having the attribute A's value v, and

Entropy(Sv) is the Entropy of Sv.

The Boosting algorithm may maximize the accuracy of a given learning algorithm. Especially, this algorithm strengthens a weak learning algorithm with the error rate of slightly lower than 50% to a strong learning algorithm and thus minimizes the error rate. Further, the Boosting algorithm may minimize the classification error rate by individually applying various weak learning algorithms such as C4.5, Decision Stump, IB1, Naïve Bayes and PART during the M times of repeated trials.

The basic idea of AdaBoost is to maintain distribution or weighed value groups for learning data groups. In other words, it is to obtain a strong classifier by using the sum of weighted values of the previously learned weak classifiers. There are two methods to learn a new classifier using weighted values: boosting by sampling and booting by weighting. In the boosting by sampling, training instances are selected, as substitutes, from the learning data groups having probabilities proportional to the weighted values. Except for the procedures for changes made during all the repetitions, this method is the re-sampling method that has the same weighted value as bagging. In the boosting by weighting, the same learning data group is given to the learning algorithm during each repetition and the weighted value is used directly to minimize the error function. The present invention adopts the boosting by weighting which learns the same data group.

The action procedures of the AdaBoost algorithm are as follows. First, the same weighted value is set for all learning data. The M times of repetitions of this algorithm are conducted by the following steps:

\mathring{1} For learning data and weighting distribution, the base classifier is established by using a weak or base learner. For example, C4.5, Decision Stump, IB1, PART, or Naïve Bayes, etc. may be used.

\mathring{2} Incorrectly classified training instances are determined from the learning data group and greater weighted values are assigned to them.

\mathring{3} Repetition is stopped after the N'th execution and the sum of the weighted values of the base classifiers is outputted.

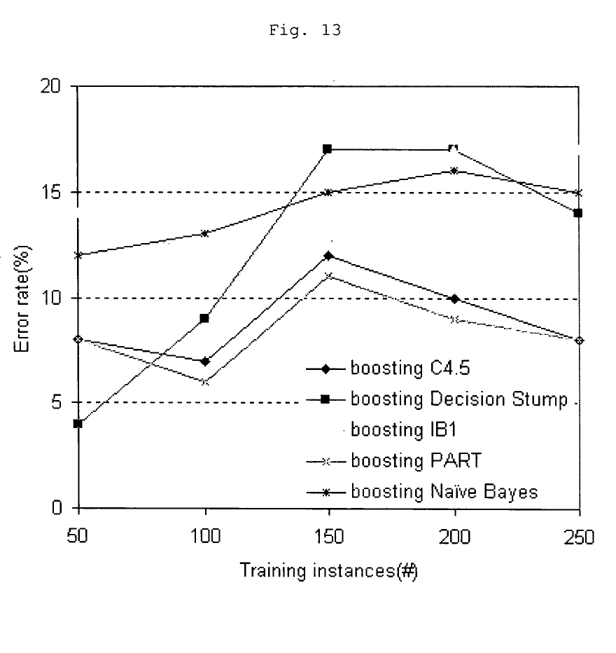

FIG. 12 illustrates procedures of the AdaBoost algorithm at each relevant step and summarizes the weighting renewal method.

Subsequently, the risk levels of external attacks may be classified according to said AdaBoost method. Table 2 shows the risk level classification on DOD and SANS.

TABLE 2
Examples of Risk Levels

| Risk Level | Description |
|---|---|
| Green | No conspicuous activity |
| (Normal | |
| Activity) | |
| Blue | Instruction and warning indicating a general threat |
| (Increasing | Local event including potential enemies having suspicious |
| Attack Risk) | or known CNA (Computer Network Attack) capabilities |
| | Activity detected by the information system probe, scan or |
| | surveillance |
| Yellow | Instruction and warning indicating an attack targeted on a |
| (Specific | specific system, location, unit or operation |
| Attack Risk) | Activity detected by the network probe, scan or |
| | concentrated reconnaissance |
| | Unauthorized penetration of the network or DOS attempted |
| | without affecting operation of the management network |
| Orange | Evaluation of an intelligent attack instructing a limited |
| (Limited | attack Information system attack having a limited influence |
| Attack) | on the management domain's operation |
| | Minimum success, successful interference |
| | Almost no or absolutely no damage in data or system |
| | Unit that can accomplish the mission |
| Red | Successful information system attack affecting operation |
| (Ordinary | of the management network |
| Attack) | Widely known incident degrading overall functions |
| | Conspicuous risk that causes mission failure |

Concerning the methods to learn knowledge base rules according to the present invention, experiments were conducted by using C4.5, DecisionStump, IB1, PART, and Naive Bayes and the relevant error rate, items such as classification speed, recall (ratio of the appropriately searched incidents to the total appropriate incidents) and precision (ratio of incidents that are fit for the search objective to the total incidents in the search result) were compared.

In said experiments, 50, 100, 150, 200 and 250 training data were used respectively upon combining various intrusion rules of SNORT and ArachNIDS and weakness information of the ICAT weakness database.

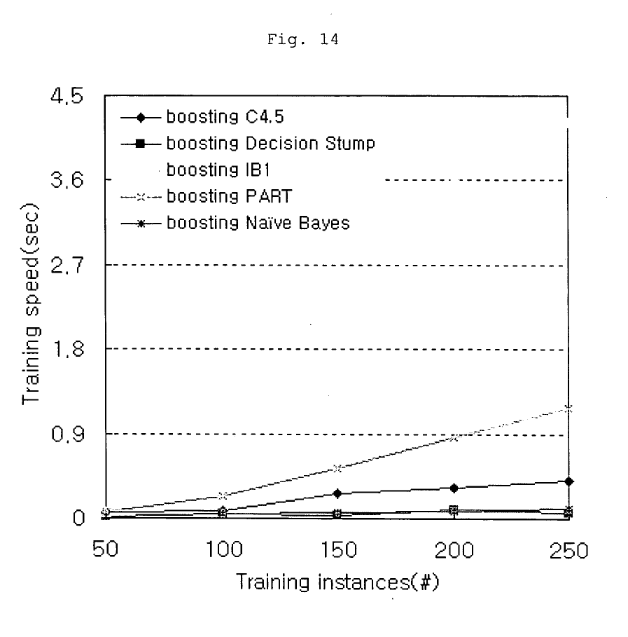

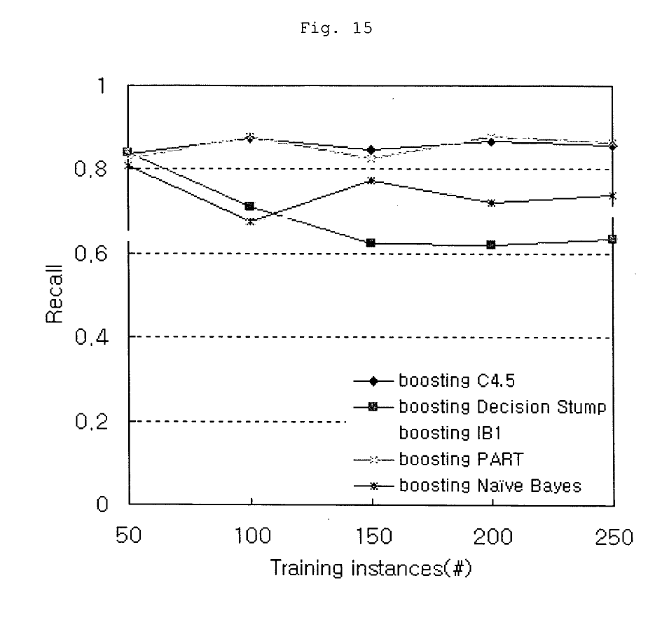

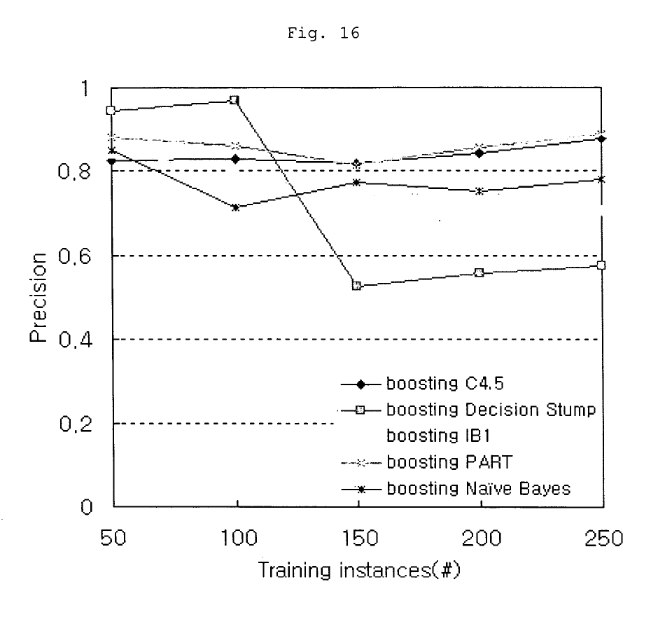

The experiment results showing classification error rate, classification speed, recall and precision are illustrated in FIG. 13 to FIG. 16. As illustrated by said experiments, the result was the best when C4.5 was used as the classification learner.

The foregoing embodiments of the present invention are merely exemplary and are not to be construed as limiting the present invention. Many alternatives, modifications and variations will be apparent to those skilled in the art.

As described above, by using the risk analysis method according to the present invention, various intrusion detection information and weakness information of the information system may be managed in an integrated manner and thus the information system's risk level against cyber attacks may be assessed automatically. Further, if an automatic intrusion response system according to the present invention is used, the large-scale network scope is treated as the response scope and the corresponding security and response policy is determined for such large-scale network scope. Thus, the security manager's management responsibility may be lightened.

1. A method of risk analysis in an automatic intrusion response system that provides computer-related security in a dynamic network environment, comprising:
(a) classifying intrusion detection information by using an IDMEF data model;
(b) establishing a risk assessment knowledge base;
(c) learning rules in said knowledge base; and
(d) assessing the risk level of an external attack based upon said learned knowledge base.

2. The method according to claim 1, wherein said assessing of risk level is by parameters such as intrusion detection information, weakness information, network bandwidth, system performance and importance, and frequency of attacks.

3. The method according to claim 1, wherein said dynamic network environment is a large-scale distributed network environment.

4. The method according to claim 1, wherein said IDMEF data model includes definitions of data format and exchange procedures for sharing information among an intrusion detection system, a response system and a management system of said automatic intrusion response system.

5. The method according to claim 1, wherein said knowledge base is established by referring to weakness information.

6. The method according to claim 1, wherein said (c) learning of rules in the knowledge base uses C4.5 machine learning technique.

7. The method according to claim 1, wherein said (d) assessing the risk level of an external attack based upon said learned knowledge base uses the AdaBoost meta learning technique.
